(19) United States
(12) Patent Application Publication
(10) Pub. No.: US 2010/0101094 A1
(43) Pub. Date: Apr. 29, 2010

(54) PIPE SEPARATION DEVICE

(75) Inventor: Achim Schneider, Radolfzell (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ILLINOIS TOOL WORKS INC., Glenview, IL (US)

(21) Appl. No.: 12/532,023

(22) PCT Filed: Jan. 29, 2008
(86) PCT No.: PCT/EP08/51053

§ 371 Date: Sep. 18, 2009

(30) Foreign Application Priority Data
Mar. 21, 2007 (DE) 10 2007 013 503.5

(51) Int. Cl. B23D 21/04; B23D 33/12

(52) U.S. Cl. 30/97; 83/520

(57) ABSTRACT

A pipe-cutting system contains a light beam implement for generating a visibly recognizable light spot on a pipe to be cut in a plane which is radial to the cutting tool's axis of rotation and which passes through the cutting edge of the cutting tool.

### RELATED APPLICATIONS

The present application is based on International Application Number PCT/EP2008/051053 filed Jan. 29, 2008, and claims priority from German Application Number 10 2007 013 503.5 filed Mar. 21, 2007, the disclosures of which are hereby incorporated by reference herein in their entirety.

### TECHNICAL FIELD

The present disclosure relates to a pipe separator device, hereafter pipe cutting system.

### BACKGROUND

Pipe cutting systems to which the present disclosure is applicable are known illustratively from one or more of the following patent documents:
CH 372 202, DE 103 52 8980 A1 (=US 2005/0,097,752 A1) and DE 101 34 269 B4. is DE 100 20 393 A1, U.S. Pat. No. 4,890,385, U.S. Pat. No. 6,065,212.

Most of the time the cutting tool is a circular saw blade, that is, its cutting edge is constituted by the sawteeth. However the cutting tool also may be in the form of a grinding cutting disk of which the outer circumference constitutes the cutting edge.

Before a predetermined length is cut off a pipe, this pipe is marked at its cut site using a pencil, a color marking pen, a scratching tool or another optic marking means. Next the pipe is positioned in the pipe receiving aperture in a manner that the pipe mark is radially aligned with the cutting tool's cutting edge. The pipe mark may be radially aligned with the axially front or rear end of the cutting tool edge, or be aligned axially centrally, depending on which pipe segment shall be of a predetermined length and how the corresponding mark was deposited on the pipe. When such pipe mark position is relative to the cutting tool, a practical problem is frequently encountered in that said mark may not be visible at all within the pipe cutting system, or only inaccurately, or only from a disadvantageous operator position. The operator therefore frequently may only estimate where the pipe mark should be applied in order to be radially aligned with the cutting tool's cutting edge. Unsurprisingly, the lengths cut off a pipe often are the wrong ones and consequently pipe waste and repeat work are incurred.

There is a need to rationalize the use of pipe cutting systems.

### SUMMARY

A pipe cutting system comprises a cutting system and a light beam implement. The cutting system comprises: a pipe receiving aperture, a cutting tool, a tool support rotatable about an axis of rotation and for holding the cutting tool, and an electric motor for rotationally driving the tool support. The axis of rotation of the tool support and the longitudinal direction of the aperture run parallel to each other. The light beam implement is for generating an optically recognizable light beam and is configured at a site remote from the tool support and on the cutting system in such a manner that the light beam is situated in a plane that is radial to the axis of rotation of the tool support and that also contains a cutting edge of the cutting tool. The light beam is adapted to be incident on a visible processing mark, previously applied on a pipe to be cut, within a zone visible from outside the pipe cutting system when said pipe to be cut runs through the pipe receiving aperture.

### BRIEF DESCRIPTION OF THE DRAWINGS

FIG. 1 is a perspective of a cutting system, and

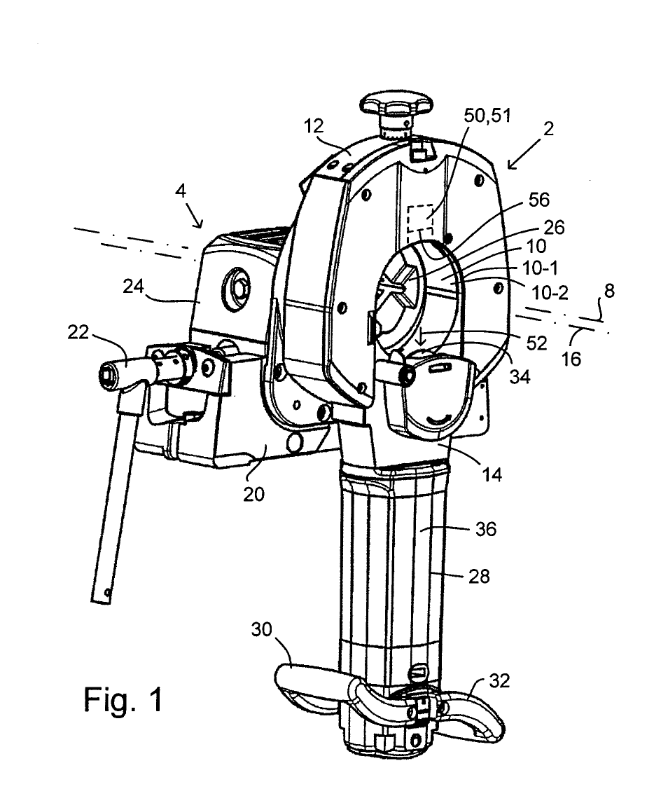

FIG. 2 is a cutaway vertical section of the pipe cutting system of FIG. 1.

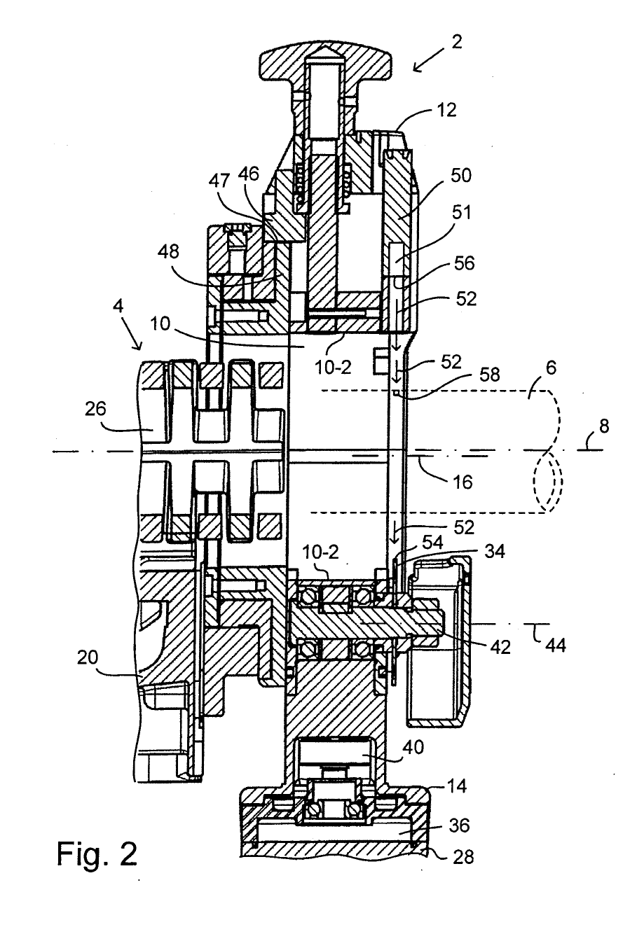

### DETAILED DESCRIPTION

The pipe cutting system shown in the drawings comprises a cutting system 2 and a clamp 4 to affix a pipe to be cut 6 along a longitudinal pipe axis 8 defined by this clamp 4, the pipe to be cut off 6 passing through a pipe receiving aperture 10 of said cutting system 2.

The pipe receiving aperture 10 runs through a housing 12 and through a slider 14 that is radially displaceable within said housing relative to said longitudinal pipe axis 8. The said aperture's longitudinal direction 16 is parallel to longitudinal pipe axis 8. The longitudinal aperture direction 16 is shown in the drawings as the center line of the pipe receiving aperture 10. This center line may be configured axially in the longitudinal pipe axis 8 or parallel thereto. The pipe receiving aperture 10 comprises a zone 10-1 subtended by the housing 12 and a zone 10-2 subtended in the slider 14, said zone 10-2 being radially displaceable relative to said zone 10-1 by displacing the slider 14.

The housing 12 of the cutting system 2 rests on a clamp base 20 so as to be rotatable about the longitudinal pipe axis 8 defined by the clamp 4.

The clamp 4 illustratively may be a vise comprising two jaws 24 and 26 driven by a threaded spindle 22 transversely to the longitudinal pipe direction 8

The slider 14 is fitted with a lever arm 28 which is designed as a grip or fitted with at least one handle 30 and/or 32 to rotate the cutting system 2 relative to the clamp 4 about the longitudinal pipe axis 8 while a cutting element 34 driven by an electric motor 36 and rotatably supported in the slider 14 engages the pipe to be cut 6. Preferably the electric motor 36 is situated within the lever arm 28.

Illustratively the electric motor 36 is rotationally linked by means of a gear unit 40 with a tool support 42. The tool support 42 for instance is a shaft rotatably resting in the slider 14. The axis of rotation 44 of the tool support 42 runs parallel to the longitudinal pipe axis 8.

In order to engage the cutting tool 34 with the pipe to be cut 6 and then disengage from them, the slider 14 may be radially displaced relative to the housing 12 by means of a cam control such as is known for instance from the Swiss patent document CH 372 202. Such a cam control may comprise a protrusion 46 which runs parallel to the longitudinal pipe axis 8 and projects away from the slider 14 and which rests on the outer circumference 47 of a cam disk 48 that is irrotationally connected to the base 20 of the pipe clamp 4.

A light beam implement 50 containing an artificial light source 51 or able to receive one is situated far away from the pipe receiving aperture 10 at the cutting system, preferably at the housing 12. The light beam implement 50 is designed in a way that, by means of said artificial light source 51, it generates a visually detectable light beam 52 that is situated in a plane radial to the axis of rotation 44 of the tool support 42 and that is directed through the pipe receiving aperture 10 onto the cutting edge of the cutting tool 54. The light beam implement 50 is configured in a manner that the light beam shall be incident, within a region visible from outside the cutting system 2, onto the pipe to be cut 6 and shall apply a visible light mark on the pipe 6 when same extends through the pipe receiving aperture 10.

The cross-section of the light beam, hence the light mark on the pipe 6, may be in the form of a light spot or a triangle of light or preferably a light line or another shape. The longitudinal direction of the light line preferably runs in the circumferential pipe direction orthogonally to the longitudinal aperture direction 16.

The light beam implement 50 preferably is a laser implement with a laser source 51 generating a laser beam projecting the light mark on the pipe to be cut 6. Another appropriate light source for instance is an LED (light emitting diode). However this listing is not limitative.

As shown in the preferred embodiment modes of the appended drawings, the cutting tool 34 is mounted at a first circumferential position of the pipe receiving aperture 10, preferably at its lower end, and the optical exit 56 of the light beam implement 50 is situated on a diametrically opposite second circumferential site of the pipe receiving aperture 10, preferably at its upper end. The concepts of “upper” and “lower” refer to the initial position of the cutting system 2 shown in the appended drawings, after a pipe cutting procedure has been completed.

As a result, the cutting system operator easily sees whether a visible processing mark 58, which has been previously applied to the pipe 6 and defines the pipe cutting site, is situated in the light beam 52 and, hence, is directly above the cutting edge 54 of the cutting tool 34.

Depending on whether it is the front or the rear of the two pipe segments to be cut apart must be of a given length, the pipe can be positioned in a way that the light beam 52 shall be incident either centrally on the mark 58 or directly at its front edge or directly next to its rear edge.

1. A pipe cutting system, comprising:
a cutting system which comprises:
a pipe receiving aperture,
a cutting tool,
a tool support rotatable about an axis of rotation and for holding the cutting tool, and
an electric motor for rotationally driving the tool support, wherein the axis of rotation of the tool support and a longitudinal direction of the aperture run parallel to each other, and
a light beam implement for generating an optically recognizable light beam and being configured at a site remote from the tool support and on the cutting system in such a manner that the light beam is situated in a plane that is radial to the axis of rotation of the tool support and that also contains a cutting edge of the cutting tool;
wherein said light beam is adapted to be incident on a visible processing mark, previously applied on a pipe to be cut, within a zone visible from outside the pipe cutting system when said pipe to be cut runs through the pipe receiving aperture.

2. The pipe cutting system as claimed in claim 1, wherein
the cutting tool is configured at a first circumferential site of the pipe receiving aperture; and
a light optical exit of the light beam implement is configured at a second circumferential site of said aperture diametrically opposite the said first site.

3. The pipe cutting system as claimed in claim 1, further comprising:
a clamp for affixing the pipe to be cut and defining the direction of the longitudinal pipe axis of said pipe to be cut,
said longitudinal pipe axis running parallel to the axis of rotation of the tool support, and
the cutting system resting on the clamp while being rotatable about the longitudinal pipe axis.

4. The pipe cutting system as claimed in claim 3, wherein
the clamp is configured at or beyond one of the two axial ends of the pipe receiving aperture, and
the light beam implement is configured at or beyond the other axial end of said pipe receiving aperture.

5. The pipe cutting system as claimed in claim 1, wherein the cutting system further comprises:
a lever arm projecting radially from the longitudinal direction of the aperture; and
at least one handle at a radially remote end of the lever arm.

6. The pipe cutting system as claimed in claim 5, wherein the lever arm contains the motor.

7. The pipe cutting system as claimed in claim 1, wherein the light beam implement comprises a laser beam implement.

8. The pipe cutting system as claimed in claim 1, wherein the light beam implement comprises an LED (light emitting diode) as a light source to generate the light beam.

9. The pipe cutting system as claimed in claim 1, wherein the cross-section of the light beam assumes the shape of a spot or a line.
